(19) United States
(12) Patent Application Publication
(10) Pub. No.: US 2019/0100417 A1
(43) Pub. Date: Apr. 4, 2019

(54) VEHICLE LIFT AND SWIVEL MOUNT

(71) Applicant: SHINN FU COMPANY OF AMERICA, INC., KANSAS CITY, MO (US)

(72) Inventors: RYAN JORGENSEN, BLUE SPRINGS, MO (US); STEVEN HUANG, KANSAS CITY, MO (US)

(21) Appl. No.: 15/724,856

(22) Filed: Oct. 4, 2017

(51) Int. Cl. B66F 5/00

(52) U.S. Cl. CPC B66F 5/00; B66F 2700/123

(57) ABSTRACT

Embodiments of vehicle lifts and swivel mounts are disclosed. A lifting system for a vehicle comprises a vehicle lift and a mount configured to attach to the vehicle lift. The mount has a saddle comprising a horizontal plate and first and second side plates extending from opposing sides of the horizontal plate; a pair of raceways disposed atop the horizontal plate defining a channel; a plurality of ball bearings disposed within the channel; a tray rotatably secured to the horizontal plate, the tray being freely rotatable atop the ball bearings; and at least one tie down secured to the saddle. A vehicle is positioned atop the mount and is rotatable via the tray. Rotation of the vehicle is temporarily impeded by strapping the vehicle to the tie down.

### BACKGROUND

The subject matter disclosed herein is directed to embodiments vehicle jacks and mounts for said jacks. In particular, embodiments of extendable apparatus capable of lifting a vehicle and swivel mounts for changing the orientation of the lifted vehicle are described. The vehicle jack may be adaptably configured to lift vehicles ranging in size from motorcycles and motor scooters, and the like, to larger vehicles such as lawn mowers. Optionally, the vehicle jack may be equipped with a swivel mount allowing for rotation of the vehicle atop the jack.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In one embodiment, a lifting system for a vehicle comprises a vehicle lift and a mount configured to attach to the vehicle lift. The mount has a saddle comprising a horizontal plate and first and second side plates extending from opposing sides of the horizontal plate; a pair of raceways disposed atop the horizontal plate defining a channel; a plurality of ball bearings disposed within the channel; a tray rotatably secured to the horizontal plate, the tray being freely rotatable atop the ball bearings; and at least one tie down secured to the saddle. A vehicle is positioned atop the mount and is rotatable via the tray. Rotation of the vehicle is temporarily impeded by strapping the vehicle to the tie down.

In another embodiment, a lifting system for a vehicle includes a life having a base and a plurality of arms operably mounted to the base and configured to move from a lowered position to a raised position and at least one platform disposed atop the arms; and a mount disposed adjacent the platform. The mount includes a saddle; and a tray rotatably disposed adjacent the saddle for receiving a vehicle. The tray rotates about a vertical axis of rotation. The mount is temporarily secured to the at least one platform; and the vehicle is rotatable about the axis of rotation when positioned atop the tray.

In still another embodiment, a system for rotatably mounting a vehicle on a lift includes a lift and a mount. The lift includes a base, a plurality of arms operably mounted to the base and configured to move from a lowered position to a raised position, and first and second platforms disposed atop the arms and laterally separated by a hollow support bar. The ends of the hollow support bar are attached to the respective platforms at respective apertures formed in the first and second platforms. The lift further includes a mechanism for raising the arms from the lowered position to the raised position and vice versa. The mount includes a saddle comprising a horizontal plate and first and second side plates extending from opposing sides of the horizontal plate, wherein the side plates have respective apertures formed therein; a pair of circular raceways disposed atop the horizontal plate defining a channel; a plurality of ball bearings disposed within the channel; a tray rotatably secured to the horizontal plate which is freely rotatable atop the ball bearings; and a connection member for securing the mount to the lift. The mount is disposed atop the platforms such that the aperture in the first side plate corresponds to the apertures in the first platform and the aperture in the second side plate corresponds to the apertures in the second platform. The connection member is inserted through the apertures in the respective side plates and platforms and secured with a mechanical fastener to attach the mount to the lift.

### BRIEF DESCRIPTION OF THE DRAWINGS

FIG. 1 is a perspective view of a lifting apparatus according to an embodiment of the invention.

FIG. 2 is a perspective view of the lifting apparatus according to the embodiment of FIG. 1.

FIG. 3 is a rear perspective view of the lifting apparatus of FIG. 1.

FIG. 4 is a side view of the lifting apparatus of FIG. 1.

FIG. 5 is a perspective view of a lifting apparatus according to another embodiment of the invention.

FIG. 6 is a perspective view of the apparatus of FIG. 4.

FIG. 7 is an exploded perspective view of a lifting apparatus.

FIG. 8 is a perspective view of a swivel mount for a lifting apparatus according to an embodiment of the invention.

FIG. 9 is a side view of the swivel mount of FIG. 7.

FIG. 10 is another side view of the swivel mount of FIG. 7.

FIG. 11 is yet another side view of the swivel mount of FIG. 7.

FIG. 12 is a top view of the swivel mount of FIG. 7.

FIG. 13 is a bottom view of the swivel mount of FIG. 7.

FIG. 14 is a bottom perspective of the swivel mount of FIG. 7.

FIG. 15 is an exploded perspective view of the swivel mount of FIG. 7.

FIG. 16 is a perspective view of the swivel mount of FIG. 7 mounted to a lifting apparatus according to an embodiment of the invention.

FIG. 17 is a bottom perspective view of the swivel mount of FIG. 16.

### DETAILED DESCRIPTION

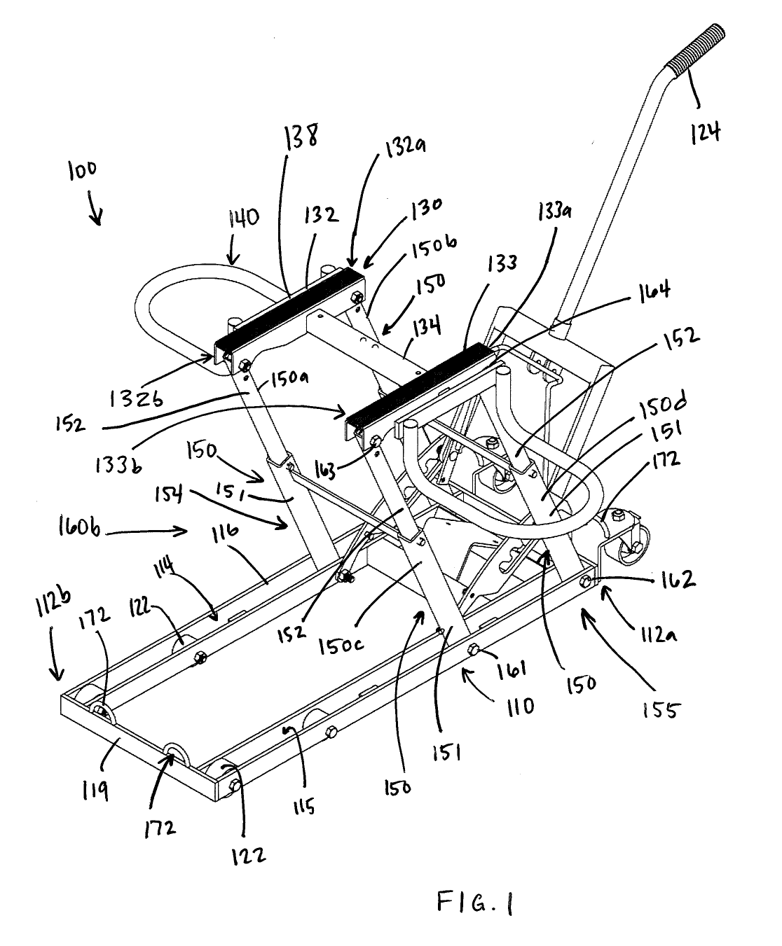

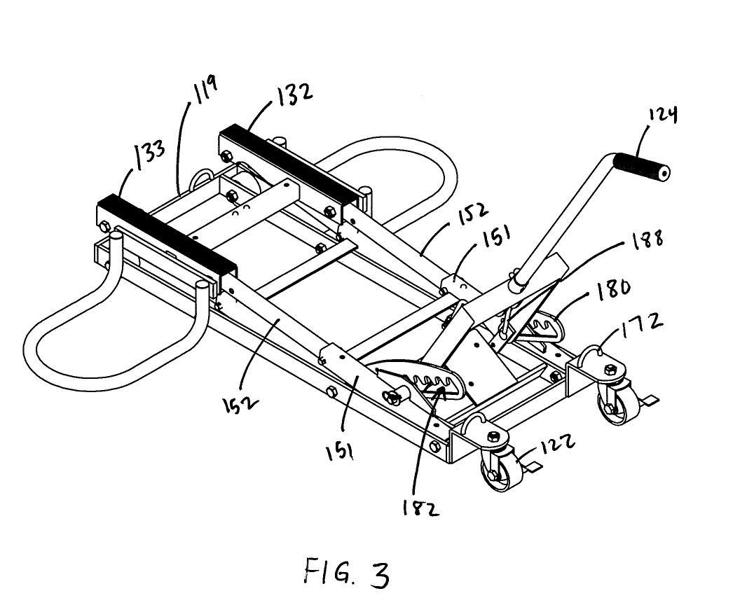

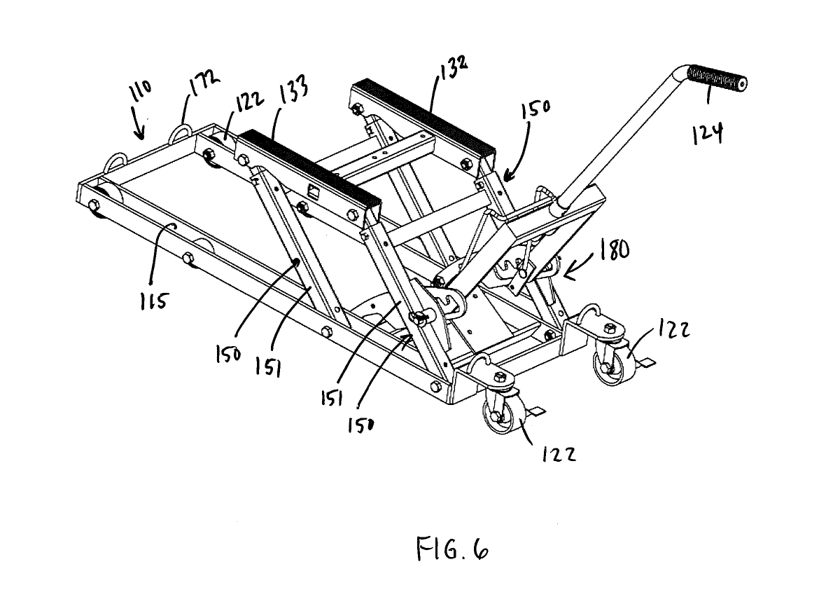

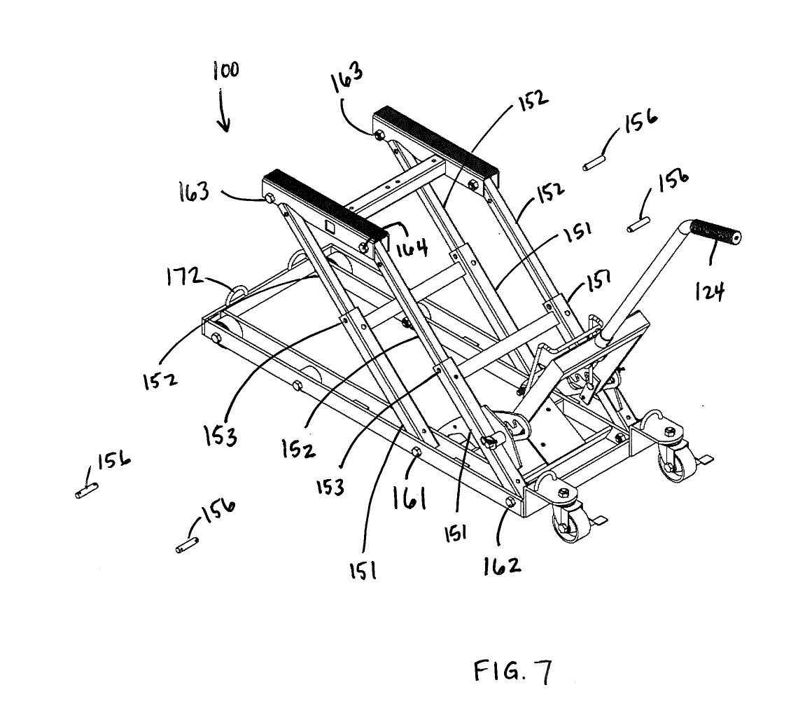

FIGS. 1-7 show an exemplary lifting apparatus 100 configured for receiving a mount according to embodiments of the invention. One exemplary lifting apparatus 100 has a base 110, a receiving portion 130, and a plurality of arms 150.

The base 110 has a proximal end 112a and a distal end 112b. Channels 114 and 115 extend generally parallel to each other from the proximal end 112a to the distal end 112b. The channels 114 and 115 have open top ends 116 and may be sufficiently long and open to allow the arms 150 to be seated, as discussed further below. A strap 119 may fix the position of the channels 114 and 115 relative to one another at the distal end 112b, and may further aid in transferring forces throughout the base 110. The position of the channels 114 and 115 may further be fixed relative to one another at the proximal end 112a. Respective plates may be provided below the channels 114 and 115 to prevent the base 110 from sinking in unstable (e.g., muddy) environments, and may further stabilize the base 110. The plates may be, for example, 1.5 mm thick steel plates.

The base 110 may include wheels 122 and a handle 124 to aid in mobility. In embodiments, one or more of the wheels 122 may be lockable in order to prevent unintentional movement of the base 110. While many types of material may be appropriate, the base 110 may be constructed of steel, aluminum, and/or other appropriate material or combinations of materials, and may be formed through welding, riveting, and/or any other appropriate processes, as is appreciated by those of skill in the art.

The receiving portion 130 includes first and second platforms 132 and 133 laterally spaced from one another. The first platform 132 has proximal and distal ends 132a and 132b, and the second platform has proximal and distal ends 133a and 133b. A support member 134 may fix the position of the first and second platforms 132 and 133 relative to one another. Optionally, the support member 134 is hollow.

Though the platforms 132 and 133 may be rectangular (as shown), it may be desirable for the platforms 132 and 133 to be L-shaped or otherwise configured such that a distance between the platform proximal ends 132a and 133a and the platform distal ends 132b and 133b is not identical. In embodiments, the platforms 132 and 133 may be configured as an oval or other non-rectangular shape. As those of skill in the art will appreciate, the platforms 132 and 133 may be constructed of steel, aluminum, and/or any other appropriate material, and may be formed through any appropriate process. In embodiments, it may be desirable to have a non-slip material 138 at an upper ends of the platforms 132 and 133, as shown.

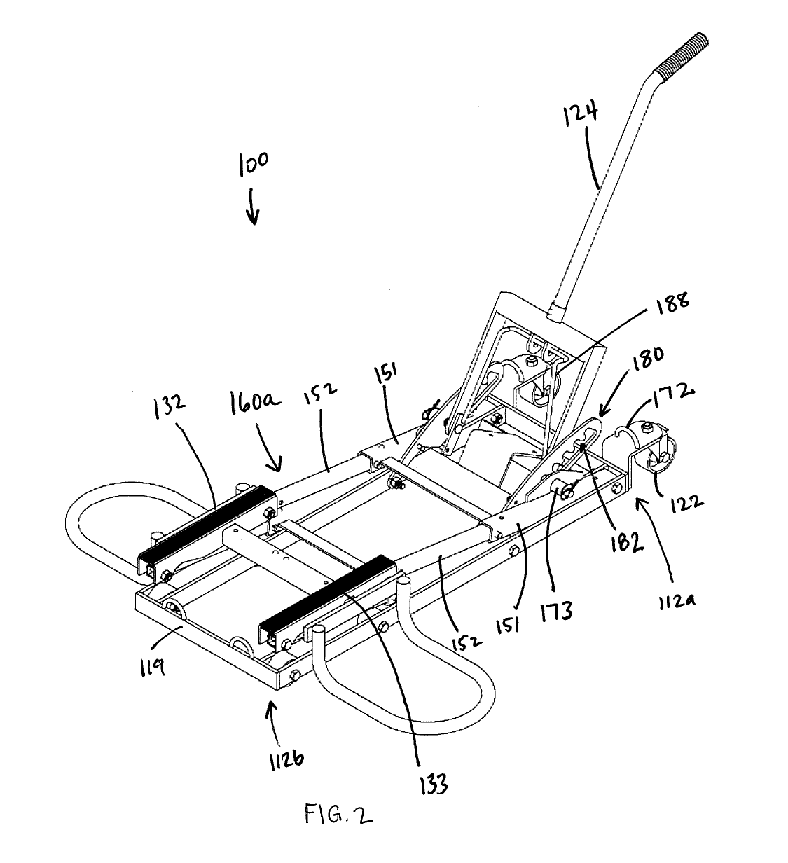

Moving on, the arms 150 (specifically denoted by arms 150a and 150b) of the first pair 154 are laterally aligned and respectively extend inside the first channel 114. The arms 150 (specifically denoted by arms 150c and 150d) of the second pair 155 are laterally aligned and respectively extend inside the second channel 115. The arms 150 are rotatably coupled to the base 110 for movement (e.g., rotation) in concert between a raised position (FIG. 1) and a lowered position (FIG. 2). While other configurations are clearly possible, it may be desirable for one arm 150 of each pair 154, 155 (e.g., arm 150a and 150c) to rotate relative to the base 110 about a generally common axis (e.g., an axis extending in line with pin 161, shown in FIG. 1), and for the other arm 150 of each pair 154, 155 (e.g., arm 150b and 150d) to rotate relative to the base 110 about another generally common axis (e.g., an axis extending in line with pin 162, shown in FIG. 1). An imaginary plane passing through the two imaginary axes may be generally horizontal such that the axes are at approximately the same relative height.

The arms 150 in the first pair 154 share a generally common axis of rotation with one another, and the arms 150 in the second pair 155 share a generally common axis of rotation with one another. In the lowered position, the arms 150a and 150b of the first pair 154 are generally longitudinally adjacent one another; similarly, the arms 150c and 150d of the second pair 155 are generally longitudinally adjacent.

All of the arms 150 are also rotatably coupled to the receiving portion 130, causing the receiving portion 130 to move between a lowered position when the arms 150 are at the lowered position 160a and a raised position when the arms 150 are at the raised position 160b. The receiving portion 130 is relatively near the base distal end 112b when the arms 150 are at the lowered position 160a, and it may be desirable for one arm 150 of each pair 154, 155 (e.g., arm 150a and arm 150c) to rotate relative to the receiving portion 130 about a generally common axis (e.g., an axis extending in line with pin 163 at the platform distal ends 132b, 133b), and for the other arm 150 of each pair 154, 155 (e.g., arm 150b and arm 150d) to rotate relative to the receiving portion 130 about another generally common axis (e.g., an axis extending in line with pin 164 at the platform proximal ends 132a, 133a). An imaginary plane passing through these two imaginary axes may remain generally horizontal, such that the receiving portion 130 stays relatively horizontal, regardless of whether the arms 150 are at the lowered or raised positions 160a, 160b. Those skilled in the art will realize that horizontal positioning is not required, so long as the arms 150, the base 110, and the receiving portion 130 form a parallelogram.

To allow rotation of the arms 150, the distance between the pin 161 and the pin 162 (and thus the axes associated with those pins) may be generally equal to the distance between the pin 163 and the pin 164 (and thus the axes associated with those pins). As shown in FIG. 1, both arms 150a, 150b of the first pair of arms 154 may be coupled to the first platform 132, and both arms 150c, 150d of the second pair of arms 155 may be coupled to the second platform 133.

The lifting apparatus 100 is configured for improved functionality over prior art lifting apparatus, in that its arms 150 are extendable such that it may lift small vehicles, such as motorcycles, scooters, and the like, as well as larger pieces of equipment, such as lawn mowers.

The arms 150 are extendable to provide greater clearance between the vehicle and the ground when larger vehicle are mounted on the lift 100 (e.g., such as lawn mowers). FIGS. 1-4 illustrate the arms 150 in an extended position. The arms 150 may each therefore have a first section 151 configured to telescopically receive a second section 152. The first section 151 may have an aperture 153 formed there through for receiving a fastening element 156 (e.g., pins). The aperture 153 in the first section 151 may correspond to one or more apertures formed in the second section 152. To extend the height of the lift, the user may simply raise the second sections 152 such that the apertures in the second section match up with the apertures 153 in the first section. It may be preferable to raise all of the arm second sections 152 at the same time, e.g., via lifting up on the support bar 134. There may be more than one aperture in each of the second sections 152, corresponding with different heights. For example, apertures may be located 6 inches, 8 inches, 10 inches, 12 inches, etc. from the top of the second section, thereby causing the height of the raised bars to be increased (or decreased, as the case may be) by a corresponding amount. Once the second sections 152 are extended to the desired position, respective fastening elements 156 may be inserted through the corresponding apertures 153 to maintain the second section 152 in position relative to the first section 151. To retract the raised bars, the fastening element 156 is simply removed, the second section 152 is telescopically received into the first section 151 to the desired location, and the fastening element 156 is reinserted into the respective apertures 153.

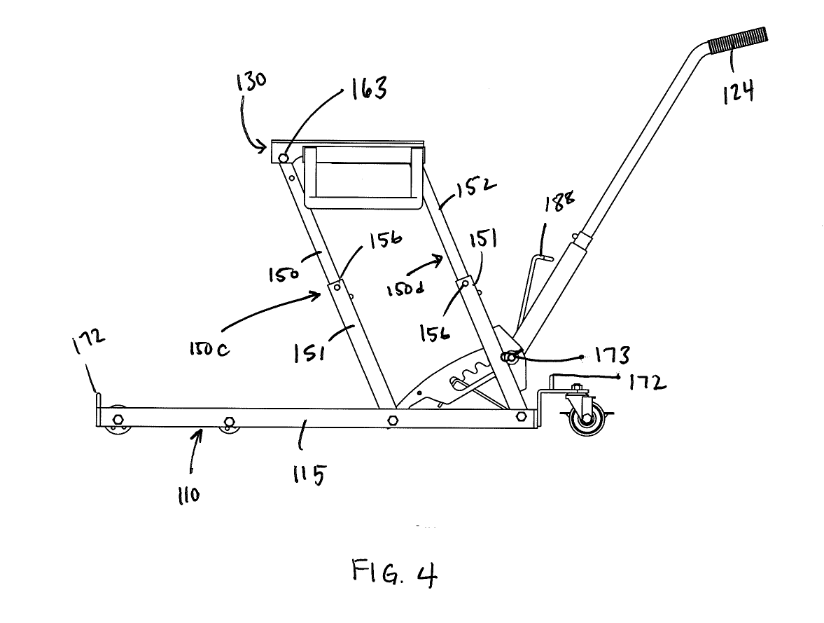

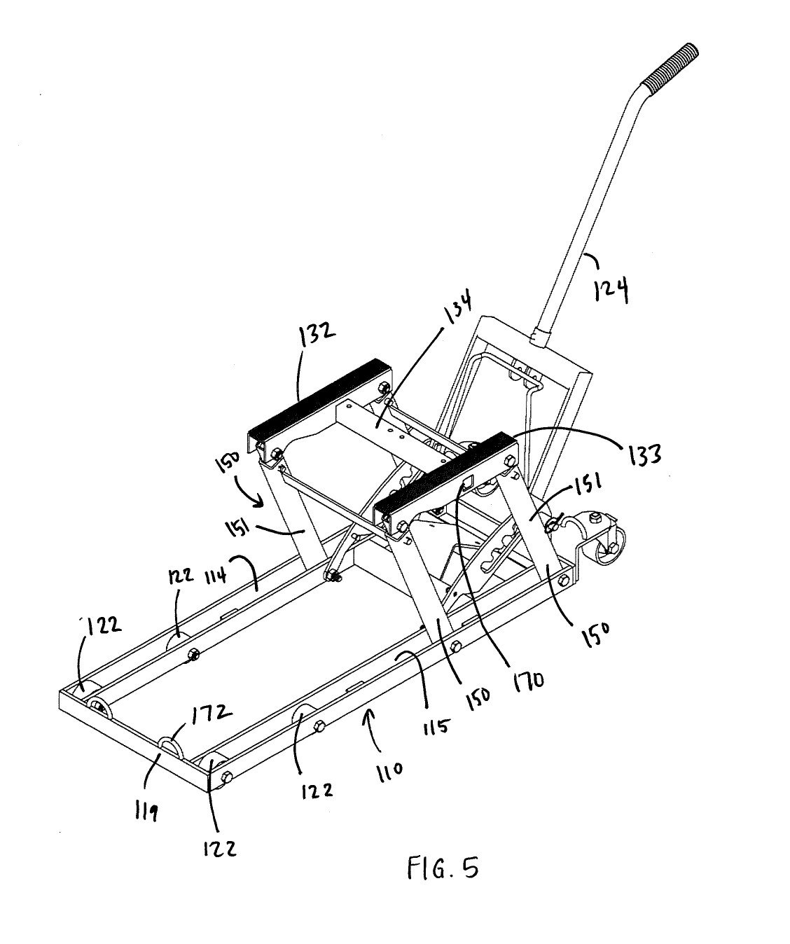

FIGS. 4 and 5 show the second sections 152 in their lowest retracted position within the first sections 151. In this configuration, the lift 100 may be suitable for use with smaller vehicles, such as a motorcycle, ATV, or scooter.

It shall be understood that the channels 114 and 115 may be sufficiently long to receive the arms 150 when the second sections 152 are fully extended. Further, those of skill in the art will appreciate that the spacing between the bars 150a and 150b and 150c and 150d may be such that the arms 150 lay substantially flat when un-extended and in the lowered position 160a. When the arms 150 are extended, the arms 150 may extend the length of the channels 114 and 115, though the arms 150 may rest atop of the channels 114 and 115, as shown in FIG. 2.

As those skilled in the art will appreciate, the arms 150 may be constructed of steel, aluminum, and/or any other appropriate material, and may be formed through any appropriate processes.

Various means for moving the pairs 154 and 155 of arms 150 between the lowered and raised positions 160a and 160b may be included. For example, a winch may be used to wind and unwind a rope or chain coupled to one of the arms 150. Or, for example, a motor and gearing may be used to rotate one of the arms 150. Or, a pump (e.g., a hydraulic or pneumatic pump) may be in communication with at least one of the arms 150 to selectively move the arms 150 between the lowered and raised positions 160a, 160b. In an embodiment, a foot pedal may be used to actuate the pump, though other inputs are of course possible.

Various means may also be included for mechanically maintaining the arms 150 at the raised position 160b to prevent the arms 150 from undesirably moving from the raised position 160b to the lowered position 160a. For example, as shown, a rack 180 may be engageable with at least one of the arms 150 (e.g., through interaction between slots 182 and the pins 173 coupled to respective arms 150) to restrict the arms 150 from leaving the raised position 160b. A release 188 is in communication with the rack 180 for selectively disengaging the rack 180 to allow the first and second pairs 154, 155 of arms 150 to move from the raised position 160b to the lowered position 160a.

The lifting apparatus 100 may be configured to be retrofit with one or more mounts to further increase the functionality of the lift 100. Optionally, in one embodiment, the receiving portion 130 may include a tire-receiving member 140 operatively coupled to each platform 132 and 133. The tire-receiving member 140 may be attached to the lift 100, for example, to aid in lifting heavier equipment such as lawn mowers. The attachment of the tire-receiving member 140 to the respective platforms 132 and 133 may be permanent or reversible (e.g., through quick-locking mechanisms, removable bolts, etc.). As shown, each platform 132 and 133 may have an aperture 170 (FIG. 5), and the tire-receiving member 140 may include a bar attached to the plates 141. The bar may be telescopically received into the aperture 170, and secured into position using mechanical fasteners (e.g., quick-locking mechanisms, removable bolts, etc.). FIGS. 1-4 show the tire-receiving members 140 coupled to the platforms 132 and 133, while FIGS. 5-7 show the platforms 132 and 133 with the tire-receiving members 140 removed. Though not specifically shown in the drawings, plates 141 may have channels that allow the tire-receiving members 140 to be adjusted along the length of the platforms 132 and 133, or the plates 141 may be received at different locations along the platforms 132 and 133 to allow for adjustment.

The tire-receiving members 140 extend outwardly from the respective platforms 132 and 133, and it may be preferable for the tire-receiving members 140 to extend outwardly below the respective platforms 132 and 133. The tire-receiving members 140 may be generally U-shaped (as shown) or provided in another appropriate configuration for securely receiving tires, and the tire-receiving members 140 may be telescopic to receive tires from vehicles have different spacing between the tires. It may be desirable for at least a portion of the tire-receiving members 140 to be rubberized to increase friction between the tire-receiving members 140 and tires being situated thereon.

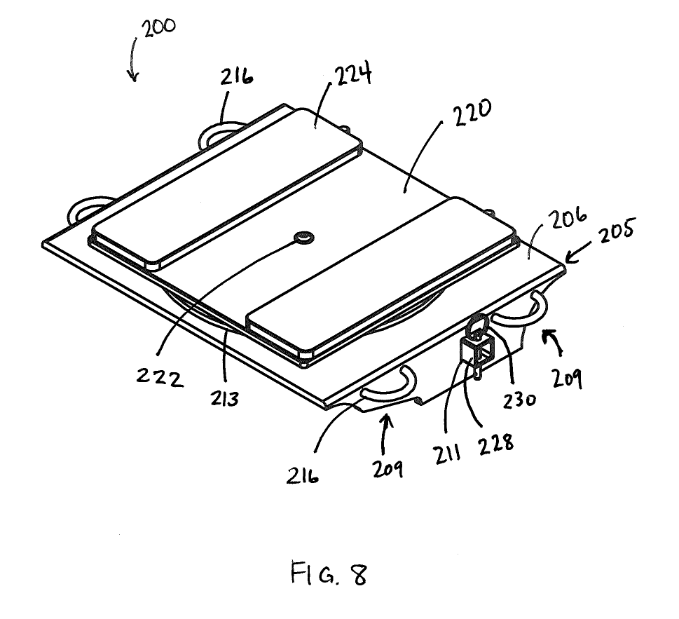

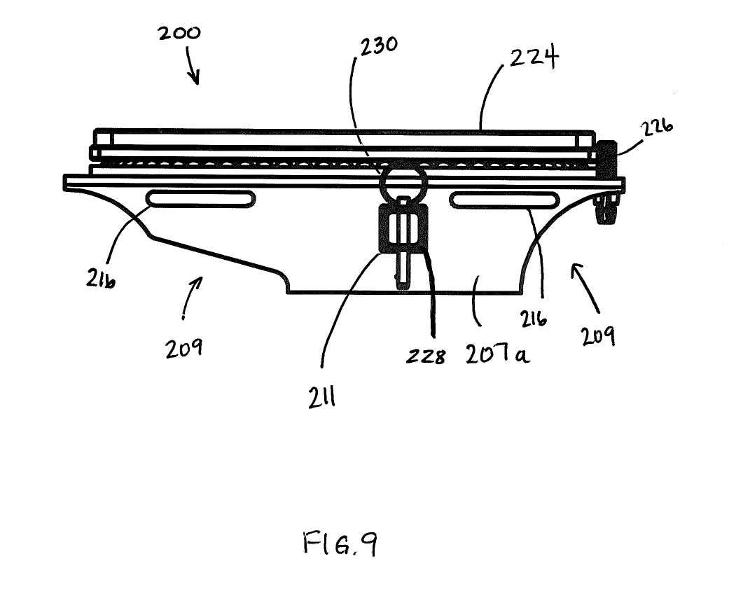

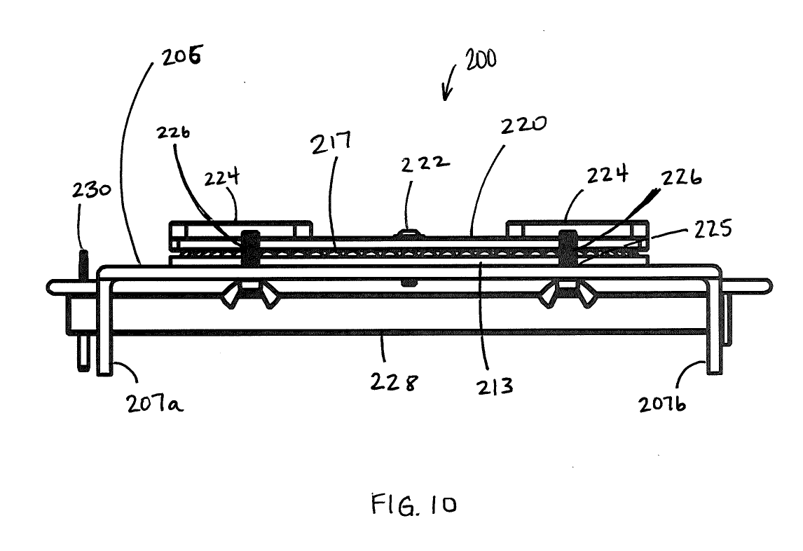

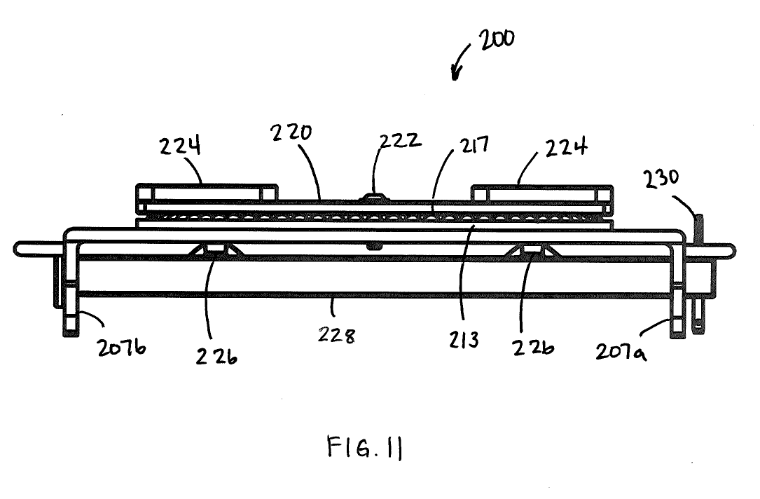

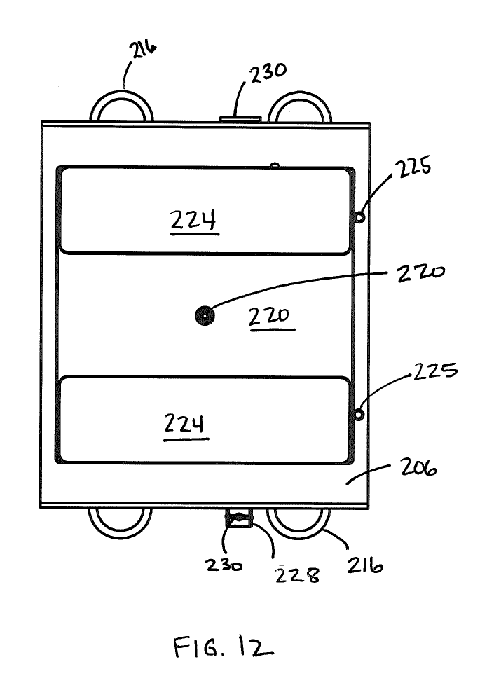

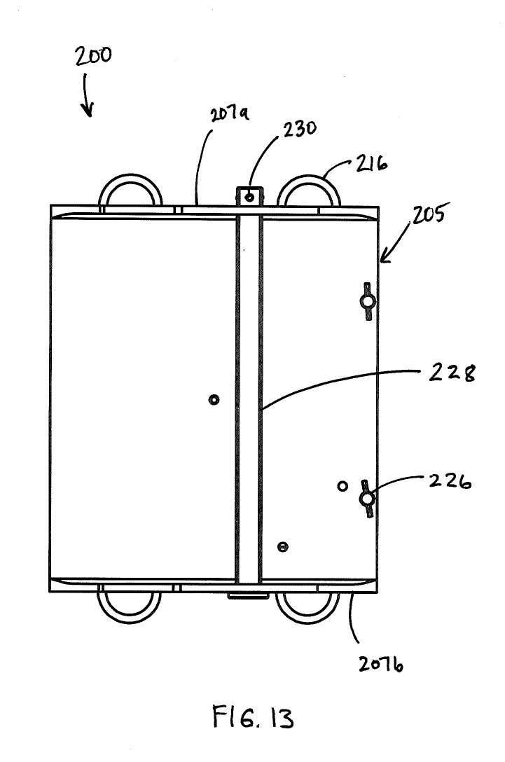

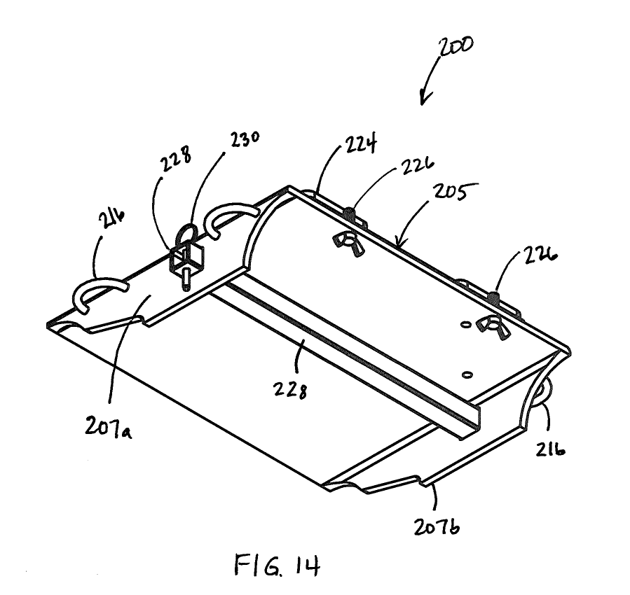

In another embodiment, the lift 100 is configured to receive a mount such as a swivel mount 200, illustrated in FIGS. 8-16. The swivel mount 200 has a saddle 205, a revolving tray 220, and means for securing the mount 200 to the lifting apparatus 100.

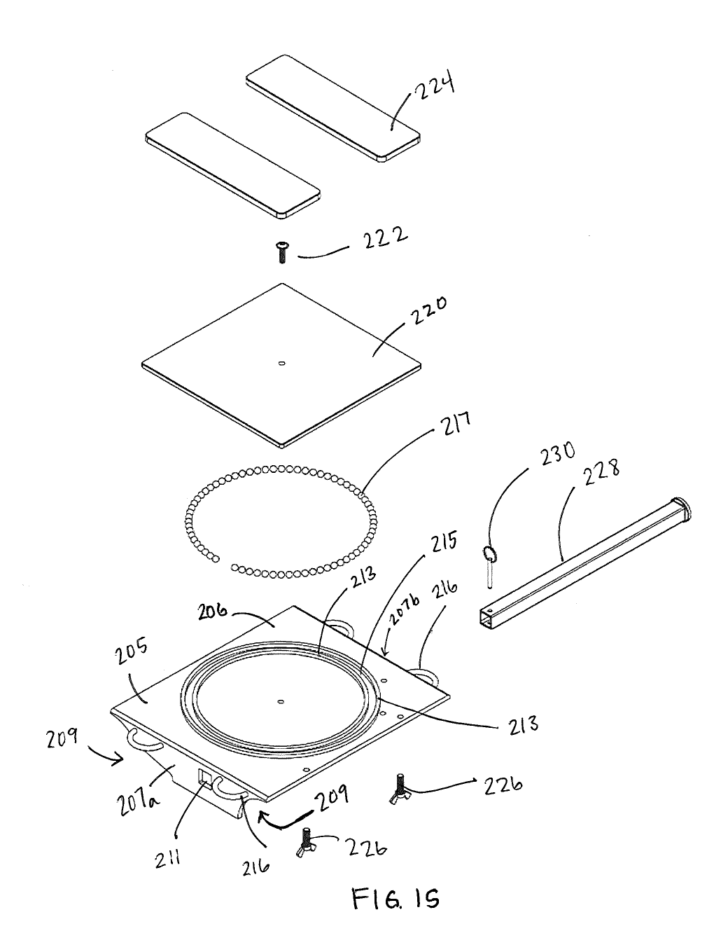

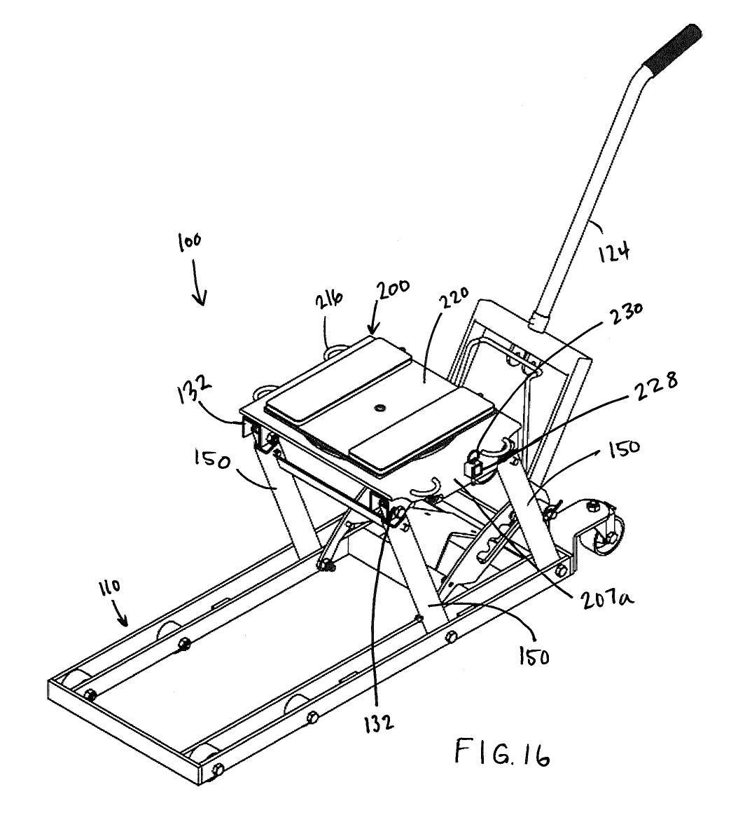

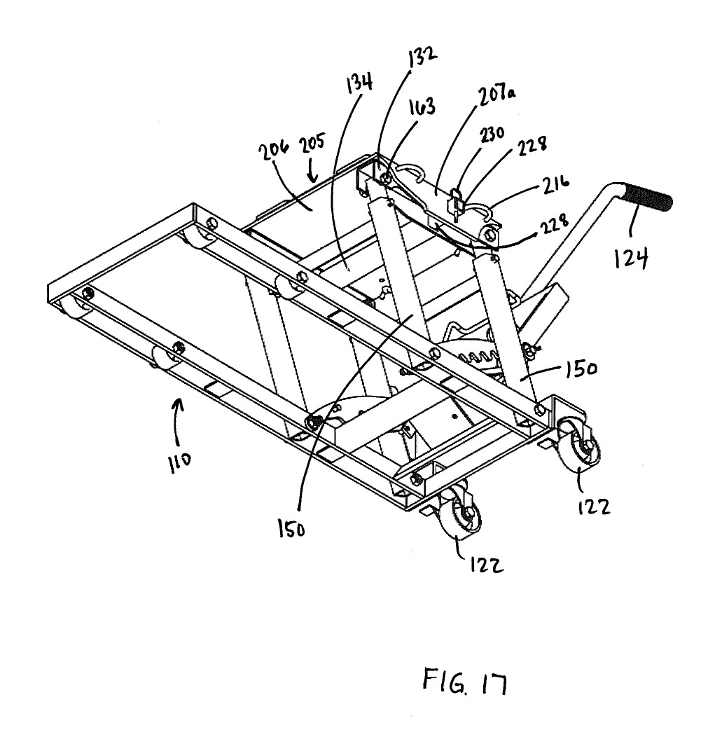

FIG. 15 best illustrates the various components of the swivel mount 200. As shown, the saddle 205 includes a substantially planar plate 206 and opposing side plates 207a and 207b. The side plates 207a and 207b extend directly from the plate 206. The side plates 207a and 207b may be spaced apart and maintained in relative position by the plate 206. The plate 206 may be sized and shaped such that the side plates 207a and 207b are disposed around the platforms 132 and 133. Optionally, when installed, the side plates 207a and 207b may abut an outer edge of the respective platforms 132 and 133 (see generally FIGS. 16 and 17).

Cutouts 209 formed into the side plates 207a and 207b provide clearance for the fasteners (e.g., pins 163 and 164) on the lifting apparatus 100. Additionally, apertures 211 may be formed in the respective side plates 207a and 207b for receiving a connection member 228. The apertures 211 correspond to respective apertures 170 in the platforms 132 and 133 of the lifting apparatus 100 for securing the saddle 205 to the lift 100 as described below.

A pair of raceways 213 deposited atop the plate 206 forms a channel 215. A plurality of ball bearings 217 are received into the channel 215 and allowed to freely translate therein. Optionally, a lubricant may be deposited into the channel 215 to further aid in the free translation of the ball bearings 217.

The revolving tray 220 is deposited atop the plate 206 and the ball bearings 217, and secured via a lock-swivel fastener 222. Preferably, the fastener 222 allows the revolving tray 220 to freely rotate atop the ball bearings 217, but prevents the revolving tray 220 from undesirably separating from the saddle 205. The revolving tray 220 is shown in a square configuration; however, those of skill in the art will appreciate that the tray 220 may take any appropriate configuration, including round, polygonal, etc.

One or more guard plates 224 are provided atop the revolving tray 220. The guard plates 224 may be permanently or temporarily adhered to the revolving tray 220. Preferably, the guard plates 224 are temporarily secured to the revolving tray 220 (e.g., using fasters, releasable adhesive, etc.) such that alternatively sized and shaped guard plates 224 may be substituted out based on the vehicle being lifted. For example, as shown, the guard plates 224 may have a substantially rectangular configuration which may be ideal for lifting vehicles such as motorcycles and the like. In other embodiments, the guard plates 224 may be slimmer, wider, or have a completely different configuration. The guard plates 224 may help to prevent the vehicle from sliding off the mount 200.

The swivel mount 200 may be desirable for use with the lift 100 when the arms 150 are in both the retracted and extended positions. Thus, the lift 100 may be configured to raise and allow rotation of many types of vehicles.

In embodiments, it may be desirable to prevent the vehicle from rotating. For example, a vehicle may be positioned on the mount 200 and raised via the lift 100 over an extended period of time. Generally, the vehicle will freely rotate atop the mount 200 via the revolving tray 220. However, a plurality of tie downs 216 may be attached to the respective side plates 207a and 207b in order that, in conjunction with a rope (or other cable), movement (including rotation) of the vehicle is impeded. The tie downs 216 may be, for example, welded to the plates 207a and 207b. To maintain the vehicle's position on the mount 200, the vehicle may be tied down using ropes secured to the tie downs 216. When secured to the tie downs 216, the vehicle may be prevented both from falling off the lift 100 and/or freely rotating atop the mount 200. Additional tie downs 172 may optionally be located on the lift 100 itself. Securing the rope to the tie downs 172, and of course the vehicle, may further prevent undesirable movement of the vehicle.

Additionally, stops 226 may be provided to further prevent rotation of the tray 220. The stops 226 may be inserted through apertures 225 in the plate 206. In embodiments, the stops 226 (and respective apertures 225) may be threaded, e.g., bolts or other threaded mechanical fasteners; alternately, the stops 226 may be a non-threaded temporary fastener, such as a clevis rod and pin combination. When in use (i.e., inserted through the apertures 225), the rotating tray 220 abuts the pins 226, thus preventing rotation thereof.

Those of skill in the art will understand that the mount 200 components may be constructed of steel, aluminum, and/or any other appropriate material, and may be formed through any appropriate process.

FIGS. 16 and 17 illustrate the mount 200 secured to the lift 100. To secure the saddle 205 to the lift 100, the saddle 205 is set atop the platforms 132 and 133 such that the apertures 211 match up with the apertures 170 in the respective platforms 132 and 133. The connection member 228 is inserted through one corresponding set of apertures 211 and 170, through the hollow support member 134, and out the other corresponding set of apertures 170 and 211. A pin 230 (or other appropriate fastening mechanism) is inserted through the connection member 228 to prevent the connection member 228 from falling out of place. One end (e.g., the end opposite the pin-receiving end) may include a plate or enlarged area which abuts the side plate 207b to prevent the connection member 228 from sliding all the way through the hollow support member 134.

While the mount 200 is described in use with the lift 100, it shall be understood by those of skill in the art that the mount 200 may be configured for use with any vehicle lift currently available or later developed.

Many different arrangements of the described invention are possible without departing from the spirit and scope of the present invention. Embodiments of the present invention are described herein with the intent to be illustrative rather than restrictive. Alternative embodiments will become apparent to those skilled in the art that do not depart from its scope. A skilled artisan may develop alternative means of implementing the disclosed improvements without departing from the scope of the present invention.

Further, it will be understood that certain features and subcombinations are of utility and may be employed without reference to other features and subcombinations and are contemplated within the scope of the claims. Not all steps listed in the various figures and description need to be carried out in the specific order described. The description should not be restricted to the specific described embodiments.

1. A lifting system for a vehicle, comprising:
a vehicle lift; and
a mount configured to attach to the vehicle lift, the mount comprising:
a saddle comprising a horizontal plate and first and second side plates extending from opposing sides of the horizontal plate;
a pair of raceways disposed atop the horizontal plate defining a channel;
a plurality of ball bearings disposed within the channel;
a tray rotatably secured to the horizontal plate, the tray being freely rotatable atop the ball bearings; and
at least one tie down secured to the saddle;
wherein:
a vehicle positioned atop the mount is rotatable via the tray; and
rotation of the vehicle is temporarily impeded by strapping the vehicle to the tie down.

2. The lifting system of claim 1, wherein the vehicle lift comprises:
a base comprising first and second parallel channels separated by a strap, the channels having an open top;
a first pair of arms operably mounted to the base and configured to move from a lowered position within the first channel to a raised position, and a second pair of arms operably mounted to the base and configured to move from a lowered position within the second channel to a raised position;
a receiving portion comprising first and second platforms disposed atop the arms and laterally separated by a hollow support bar, the ends of the hollow support bar being attached to the respective platforms at respective apertures formed in the first and second platforms; and
a mechanism for raising the lift from the lowered position to the raised position.

3. The lifting system of claim 1, wherein the each of the first pair of arms and the second pair of arms comprises a front arm and a rear arm, wherein the respective front arms rotate relative to the base about a first axis of rotation, and wherein the respective rear arms rotate relative to the base about a second axis of rotation, the first and second axes of rotation being parallel.

4. The lifting system of claim 2, wherein each arm comprises a first section operatively connected to the base and a second section telescopically received into the first section, wherein the second section is extendable relative to the first section.

5. The lifting system of claim 4, wherein the second section is secured to the first section with a mechanical fastener.

6. The lifting system of claim 2, wherein the mount is disposed atop the lift such that the horizontal plate is substantially adjacent a top edge of the first and second platforms, and the respective first and second side plates are substantially adjacent an outside edge of the respective first and second platforms.

7. The lifting system of claim 6, wherein the first and second platforms and first and second side plates have respective corresponding apertures formed therein, the aperture in the first side plate matching up with the apertures in the first platform and the aperture in the second side plate matching up with the apertures in the second platform when the mount is disposed atop the lift.

8. The lifting system of claim 7, wherein a connection member is inserted through the respective apertures in the first side plate and the first platform, the hollow support bar, and the respective apertures in the second platform and the second side plate to secure the mount to the lift.

9. The lifting system of claim 1, wherein the mount further comprises a guard plate adhered to the tray.

10. The lifting system of claim 1, wherein the mount further comprises openings formed into the horizontal plate for receiving a stop, the stop preventing rotation of the tray.

11. The lifting system of claim 10, wherein the stop is a threaded mechanical fastener.

12. The lifting system of claim 2, wherein at least one tie down is attached to the base of the lift, and wherein the vehicle is strapped to the tie down on the base of the lift to further prevent movement of the vehicle on the lift.

13. A lifting system for a vehicle, comprising:
a lift, comprising:
a base;
a plurality of arms operably mounted to the base and configured to move from a lowered position to a raised position; and
at least one platform disposed atop the arms; and
a mount disposed adjacent the platform, the mount comprising:
a saddle; and
a tray rotatably disposed adjacent the saddle for receiving a vehicle, the tray rotating about a vertical axis of rotation;
wherein:
the mount is temporarily secured to the at least one platform; and
the vehicle is rotatable about the axis of rotation when positioned atop the tray.

14. The lifting system of claim 13, wherein the saddle comprises:
a planar panel and first and second side plates extending from opposing sides of the panel;
a pair of circular raceways disposed atop the panel defining a channel; and
a plurality of ball bearings disposed within the channel;
wherein the tray rotatably secured to the horizontal plate, the tray being freely rotatable atop the ball bearings.

15. The lifting system of claim 13, wherein the base comprises first and second parallel channels separated by a strap, the channels having an open top; and wherein the plurality of arms comprises a first pair of arms aligned in a first vertical plane and a second pair of arms aligned in a second vertical plane, the first and second planes being generally parallel.

16. The lifting system of claim 15, wherein each arm comprises a first section operatively connected to the base and a second section telescopically received into the first section, wherein the second section is extendable relative to the first section.

17. The lifting system of claim 16, wherein the base further comprises wheels.

18. A system for rotatably mounting a vehicle on a lift, comprising:
a lift, comprising:
a base;
a plurality of arms operably mounted to the base and configured to move from a lowered position to a raised position;
first and second platforms disposed atop the arms and laterally separated by a hollow support bar, the ends of the hollow support bar being attached to the respective platforms at respective apertures formed in the first and second platforms; and
a mechanism for raising the arms from the lowered position to the raised position and vice versa; and
a mount, the mount comprising:
a saddle comprising a horizontal plate and first and second side plates extending from opposing sides of the horizontal plate, the side plates having respective apertures formed therein;
a pair of circular raceways disposed atop the horizontal plate defining a channel;
a plurality of ball bearings disposed within the channel;
a tray rotatably secured to the horizontal plate, the tray being freely rotatable atop the ball bearings; and
a connection member for securing the mount to the lift;
wherein:
the mount is disposed atop the platforms such that the aperture in the first side plate corresponds to the apertures in the first platform and the apertures in the second side plate corresponds to the apertures in the second platform; and
the connection member is inserted through the apertures in the respective side plates and platforms and secured with a mechanical fastener to attach the mount to the lift.

19. The system of claim 18, wherein each arm comprises a first section operatively connected to the base and a second section telescopically received into the first section, wherein the second section is extendable relative to the first section.

20. The system of claim 19, wherein a vehicle is disposed atop the tray, the vehicle being rotatable on the tray; and wherein, at least one of the lift and the mount further comprises a mechanism for preventing rotation of the vehicle, the mechanism comprising one of a tie down and a temporary stop.
